(19) United States
(12) Patent Application Publication
(10) Pub. No.: US 2017/0121091 A1
(43) Pub. Date: May 4, 2017

(54) REMOVABLE BOTTOM, FOOD TRAY AND METHOD FOR PRODUCING SUCH A FOOD TRAY

(71) Applicant: TORUS PAK RESEARCH AND DEVELOPMENT S.A.R.L, Luxembourg (LU)

(72) Inventor: Rickard Gillblad, Onsala (SE)

(21) Appl. No.: 15/319,678

(22) PCT Filed: Jun. 17, 2015
(86) PCT No.: PCT/EP2015/063655

§ 371 Date: Dec. 19, 2016

(30) Foreign Application Priority Data
Jun. 17, 2014 (EP) PCT/EP2014/062770

(51) Int. Cl. B65D 77/30; B65D 1/34; B29C 45/00; A23L 5/00; B29C 51/00; A47G 23/06; B65B 7/28

(52) U.S. Cl. CPC B65D 77/30; A47G 23/06; B65D 1/34; B65B 7/28; A23L 5/00; B29C 51/002; B29C 45/0001; A23V 2002/00; B29K 2023/12

(57) ABSTRACT

A removable bottom adapted to be attached to a lower rim of a food tray in a detachable manner, where the removable bottom comprises a removal tab, where the removal tab is a separate removal tab fixedly attached to the removable bottom by an attachment section. One advantage of the invention is that a food tray having a removable bottom is provided for in an easy and cost-effective way. In this way, a food tray that allows food to be transferred from the bottom of the food tray to a serving surface by removing the bottom is obtained.

### TECHNICAL FIELD

The present invention relates to a food tray adapted for ready meals and the like comprising a removable bottom and a method for producing such a food tray.

### BACKGROUND ART

There is an increasingly large demand for meals that are simple to prepare and for which the preparation time is short. Sales of convenience foods or ready meals are increasing. These are sold in disposable packages and are adapted either to be eaten directly without heating, such as sushi, or to be heated before eaten.

Most ready meals are contained in a disposable package usually consisting of a tray manufactured from cardboard, metal or a plastic material with a thin, transparent plastic film serving as a lid. A plurality of different heating methods is available, depending on the packaging material. The most common tray material for single portion ready meals is plastic or paper, which allows the meal to be heated in a microwave oven. It is also possible to use a conventional oven or to place the package in hot water. The lid of the package is removed either before or after heating. The meal can be eaten directly from the package when heated or it is possible to transfer the food from the package to a plate. During a transfer of the food, the presentation of the meal is destroyed and the food content will inevitable mix. If the food is frozen, it may be possible to transfer the food to a plate prior to heating without too much problems, but for a non-frozen meal, the transfer of food is not practical. It is further an advantage to heat the meal in the package before moving it to a plate.

One way of solving the problem with the food mixing is to use a food package having a removable bottom, which is removed by the use of a pulling tab. The food package is placed on a plate before or after it is heated, and the bottom is removed by the use of the pulling tab. In this way, the food will be placed on the plate with the same presentation as in the food package, which will enhance the eating experience. Such a food package is disclosed in WO 2006/115457.

Such a food package is produced by injection moulding a container part without a bottom, i.e. a container part substantially only comprising side walls with upper and lower rims is produced. A removable bottom consisting of a relatively thin foil is then attached to the bottom rim of the container part in a detachable manner. The removable bottom comprises a removal tab to be used to remove the bottom.

Since food packages are disposable, production cost is an important parameter. One problem with the known food packages having a removable bottom is that it is relatively expensive and complicated to attach a removable bottom provided with a removal tab to a food tray in a detachable manner. The removable bottom is supplied as a roll of foil which is heat sealed in a detachable manner to the lower rim of a food tray. In order to be able to attach the removable bottom in a detachable manner, a relatively expensive foil comprising a plurality of different layers must be used, and the attachment procedure must be monitored in detail. When the removable bottom is attached to the food tray, the bottom is cut out from the roll of foil. Since the removal tab extends out from the removable bottom, and must extend over more than the length of the removable bottom, it must be cut with special tools and must further be handled with special tools such that the removable bottom is not peeled off during the handling of the removal tab.

There is thus room for an improved food tray having a removable bottom.

### DISCLOSURE OF INVENTION

An object of the invention is therefore to provide an improved removable bottom comprising a removal tab. A further object of the invention is to provide an improved food tray comprising a removable bottom. A further object of the invention is to provide a method for producing an improved food tray comprising a removable bottom.

The solution to the problem according to the invention is described in the characterizing part of claim 1 for the removable bottom, in claim 7 for the food tray and in claim 8 for the method. The other claims contain advantageous embodiments and further developments of the removable bottom and of the method.

In a removable bottom adapted to be attached to a lower rim of a food tray in a detachable manner, where the removable bottom comprises a removal tab, the object of the invention is solved in that the removal tab is a separate removal tab fixedly attached to the removable bottom by an attachment section.

By this first embodiment of the removable bottom according to the invention, a removable bottom having a separately attached removal tab is provided for. The removal tab is fixedly attached to the removable bottom after the removable bottom is attached to the side wall module of the food tray in a detachable way. In this way, the attachment of the removable bottom to the lower rim is simplified considerably. The attachment of a removable bottom to a food tray in a detachable manner is a relatively expensive and difficult process. Since the attachment of the removable bottom is made by a heat sealing process, it is important that the heating properties are absolutely right. If the attachment is not heated enough, the removable bottom will not adhere to the lower rim and the bottom may leak, and if the attachment is heated too much, the removable bottom will be difficult to remove. This process is complicated when a removal tab has to be cut out and handled at the same time.

A further advantage of attaching a separate removal tab to the removable bottom is that a cheaper material can be used for the removal tab. The material used for the removable bottom is a relatively expensive foil comprising a plurality of different layers which allows the foil to be attached to the lower rim in a detachable manner and which still provides a reliable attachment to the lower rim before the removable bottom is removed. Since the removal tab is fixedly attached to the removable bottom, the foil material used for the removal tab can be a cheaper and simpler material. At the same time, the waste of material can be reduced, since the removal tab must not be cut from the same roll of foil and on the same time as the removable bottom is cut.

A further advantage of attaching a separate removal tab to the removable bottom is that a cheaper material can be used for the removal tab. The material used for the removable bottom is a relatively expensive foil comprising a plurality of different layers which allows the foil to be attached to the lower rim in a detachable manner and which still provides a reliable attachment to the lower rim before the removable bottom is removed. Since the removal tab is fixedly attached to the removable bottom, the foil material used for the removal tab can be a cheaper and simpler material.

The removal tab can either be attached to a corner of the removable bottom, or to a short side of the removable bottom. The removal tab is attached to the removable bottom after the removable bottom is attached to the lower rim of the side wall module. One advantage of attaching the removal tab at a later stage is that the detachable heat seal between the removable bottom and the lower rim will cool down, which reduces the risk of damaging the seal when handling the removal tab.

The removal tab may in one example be attached to the removable bottom inside the heat seal between the removable bottom and the lower rim. In this way, the attachment section of the removal tab will be fixedly attached to the removable bottom and the removal tab will be double folded.

It is also possible to attach the removal tab to a bottom attachment section extending from the removable bottom, outside the heat seal between the removable bottom and the lower rim. In this way, the attachment section of the removal tab will be fixedly attached to the bottom attachment section of the removable bottom, and the bottom attachment section will be double folded together with the attachment section of the removal tab.

In a method for producing a food tray, where the food tray comprises a side wall module and a removable bottom attached to a lower rim of the side wall module in a detachable manner, and where the removable bottom can be removed from the side wall module by the use of a removal tab attached to the removable bottom, the method comprises the steps of producing a side wall module having side walls and a lower opening, attaching a bottom foil to a lower rim of the side wall module in a detachable manner, and fixedly attaching the removal tab to the removable bottom.

By this first embodiment of the method for producing a food tray according to the invention, the method comprises the step of first attaching a bottom foil in a detachable manner to a lower rim of a side wall module of a food tray. The removal tab is thereafter attached to the removable bottom in a fixed manner. By using a separate removal tab that is fixedly attached to the removable bottom, the production of a food tray having a removable bottom is simplified. The removal tab is fixedly attached to the removable bottom after the removable bottom is attached to the lower rim of the side wall module. The removal tab can either be attached directly to the removable bottom or to a bottom attachment section extending from the removable bottom.

### BRIEF DESCRIPTION OF DRAWINGS

The invention will be described in greater detail in the following, with reference to the embodiments that are shown in the attached drawings, in which

FIG. 1 shows a side view of a food tray comprising a removable bottom according to the invention,

FIG. 2 shows a bottom view of an example of a food tray according to the invention,

FIG. 3 shows a bottom view of another example of a food tray according to the invention,

FIG. 4 shows a bottom view of a further example of a food tray according to the invention,

FIG. 5 shows a bottom view of a further example of a food tray according to the invention, and

FIG. 6 shows a schematic flow chart of the method according to the invention.

### MODES FOR CARRYING OUT THE INVENTION

The embodiments of the invention with further developments described in the following are to be regarded only as examples and are in no way to limit the scope of the protection provided by the patent claims.

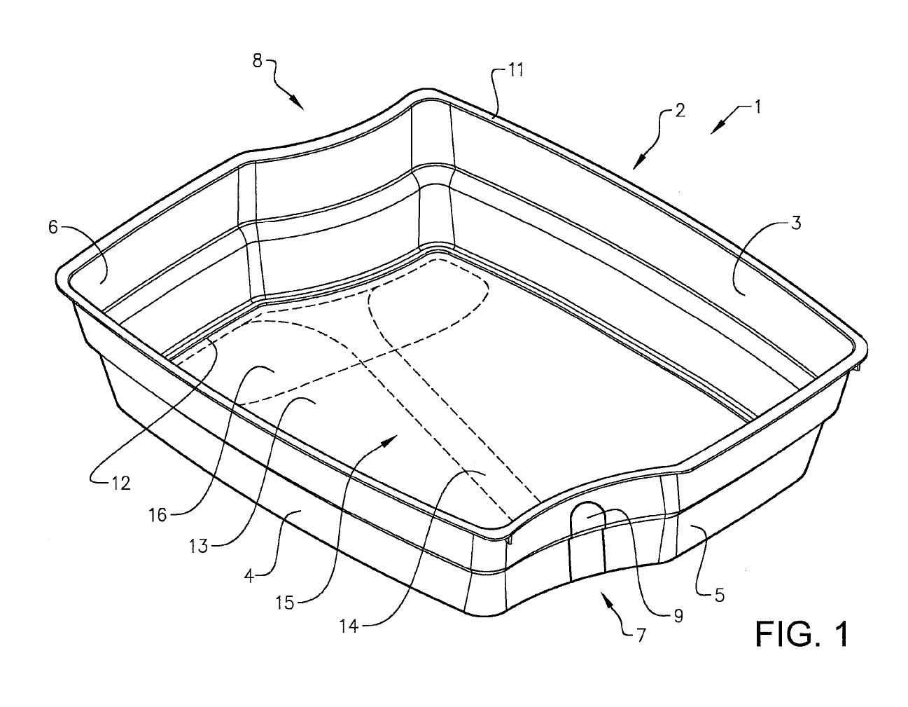

FIG. 1 shows an embodiment of a food package in the form of a food tray 1. The food tray 1 comprises in the shown example a side wall module 2 having two longitudinal side walls 3, 4 and two transverse side walls 5, 6 interconnected to each other, thereby forming the side wall module 2 made in one piece. The food tray further comprises a removable bottom 13 attached to the lower rim 12 of the side wall module. The removable bottom 13 closes off a lower opening 15 of the side wall module 2. The side walls 3, 4 and 5, 6 are substantially perpendicular to each other, but the side wall module may also have other shapes, such as a round, an oval or an asymmetric shape. A rectangular outer shape is however cost-efficient both to handle and to pack in larger quantities. The shown transverse side walls each comprise a concave section 7, 8. The concave section 7 is intended to hold the handle 9 of the removal tab 14 of the removable bottom and to provide a grip for holding the food tray when the removable bottom is removed. The removal tab 14 is fixedly attached to the removable bottom at the opposite end, at the side of the concave section 8, which means that the removable bottom will start to peel off from this end when the removal tab is pulled. The transverse side wall 5 together with the concave section 7 is also referred to as the handle side of the food tray.

The side walls slope somewhat such that the food trays can be stacked in each other. This allows for an efficient transportation of empty food trays. The lower periphery of the side wall module is provided with a lower rim 12 that is adapted to receive a bottom foil that will constitute the removable bottom 13 of the food tray. The bottom foil is attached to the underside of the lower rim 12 in a removable manner, i.e. to the outer side of the lower rim, such that a removable bottom is provided.

The removable bottom is attached to the outer side of the lower rim. This is of advantage when the side wall module is produced by injection moulding. Here, the side wall module is produced with the lower rim 12 pointing upwards and with the side wall module “upside down”, i.e. in the opposite orientation as the food tray is to be used. A foil is then applied from a roll of foil to the lower rim and the foil is heat sealed to the rim such that the bottom foil attaches to the rim in a detachable manner. When the bottom foil is attached to the rim, it is cut out from the roll of foil.

The bottom foil can be removed by pulling the handle 9 of the removal tab 14. The removable bottom foil is preferably attached in a removable manner to the side wall module when the food tray is produced. There are different ways of achieving an attachment of the bottom that allows it to be removed in an easy way, but that will still provide a secure bottom for the food before the removal of the bottom. Since the removable bottom is peeled off, the local pulling strength acting on the joint will be relatively high which helps the removal of the bottom.

The upper periphery of the food package comprises an upper rim 11 that is adapted to receive a lid of some kind. The lid may be made from different materials but is preferably a transparent film that is attached to the upper rim after food has been placed in the tray. The lid does not have to be removed from the tray when the food in the tray is to be served. The lid may thus be attached to the upper rim in a fixed manner. This allows for an easier attachment of the lid, which is of great importance especially when the food tray is used by smaller establishments having simpler sealing machines. A removable lid requires higher tolerances when the lid is attached to the tray, but with the inventive tray, a tight and secure attachment of the lid may be obtained also with lower tolerances.

The side wall module 2 is provided with a lower opening 15 delimited by the lower rim 12 of the side wall module. The lower opening covers substantially the complete bottom plane of the side wall module. In this way, everything that is placed on the removable bottom 13 in the food tray will arrive at the plate on which the food tray is placed, when the removable bottom is removed. The side wall module is preferably injection moulded in polypropylene (PP), also known as polypropene. Polypropylene has good injection moulding properties and is relatively cheap and is further recyclable which is of advantage for disposable packages.

The removal tab is attached to the removable bottom in a fixed way, after the removable bottom has been attached to the lower rim of the side wall module. The removal tab 14 is provided with an attachment section 16 which is used to attach the removal tab to the removable bottom. The attachment section 16 is wider than the removal tab such that a proper force distribution is obtained. The removal tab is attached to the removable bottom using e.g. a heat seal, glue or adhesive.

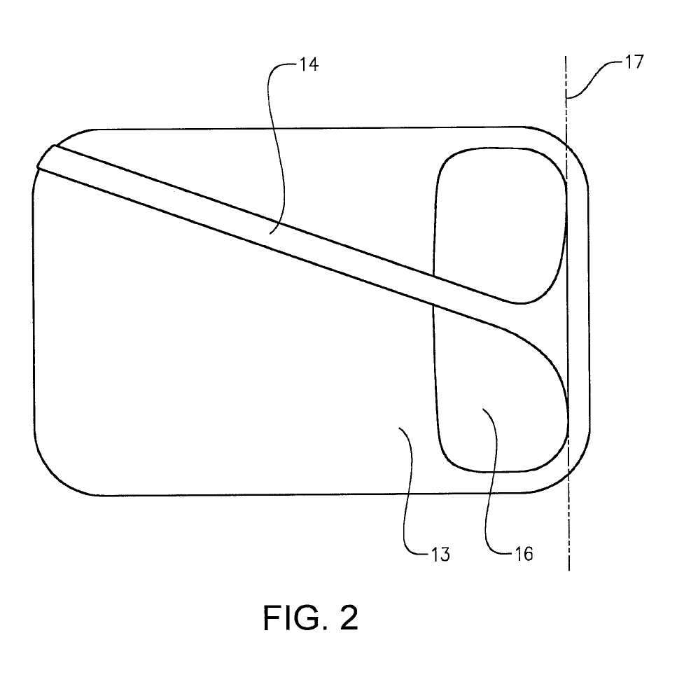

FIG. 2 shows a bottom view of an example of a food tray according to the invention. In this example, the attachment section 16 of the removal tab extends along a complete short side of the removable bottom. It is further shown that the attachment section of the removal tab is attached close to the seal between the removable bottom and the lower rim of the side wall module, such that the removable bottom will peel off easily when the removal tab is pulled. The removal tab is applied to the removable bottom with a slight angle with respect to a longitudinal side wall, such that the removable bottom will start to peel off in one corner. This simplifies the removal of the removable bottom since the pulling forces will act with an angle, starting to remove the removable bottom at a corner. The removal tab is double folded along a folding line 17 and the handle 9 of the removal tab is attached to the opposite side wall in a removable way, such that the handle is held in place before the tab is to be pulled. The removal tab is folded along the folding line after the removable tab is attached to the removable bottom.

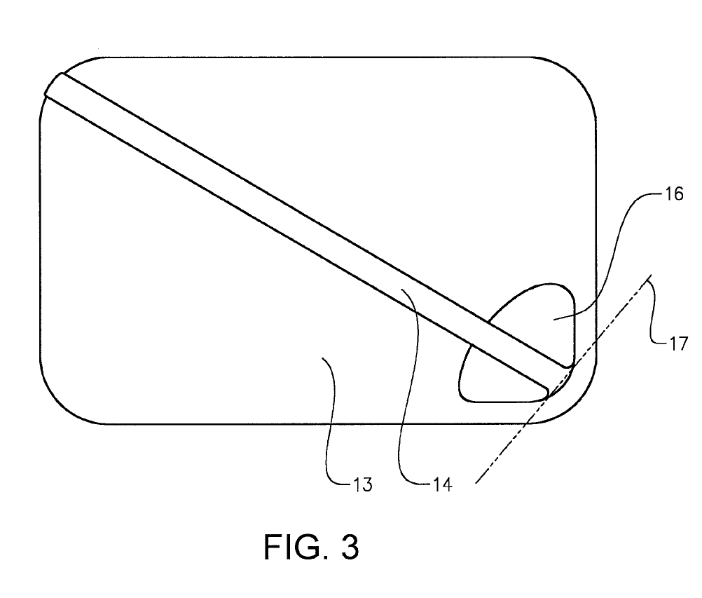

FIG. 3 shows a bottom view of another example of a food tray according to the invention. In this example, the attachment section 16 of the removal tab is attached to a corner of the removable bottom. The attachment section of the removal tab is attached close to the seal between the removable bottom and the lower rim of the side wall module, such that the removable bottom will peel off easily when the removal tab is pulled. The removal tab will in this way extend diagonally over the removable bottom, such that the removable bottom will start to peel off in one corner. This simplifies the removal of the removable bottom since the pulling forces will act with an angle, starting to remove the removable bottom at a corner. The removal tab is double folded along a folding line 17 and the handle 9 of the removal tab is attached to the side wall at the opposite corner in a removable way, such that the handle is held in place before the tab is to be pulled. The removal tab is folded along the folding line after the removable tab is attached to the removable bottom.

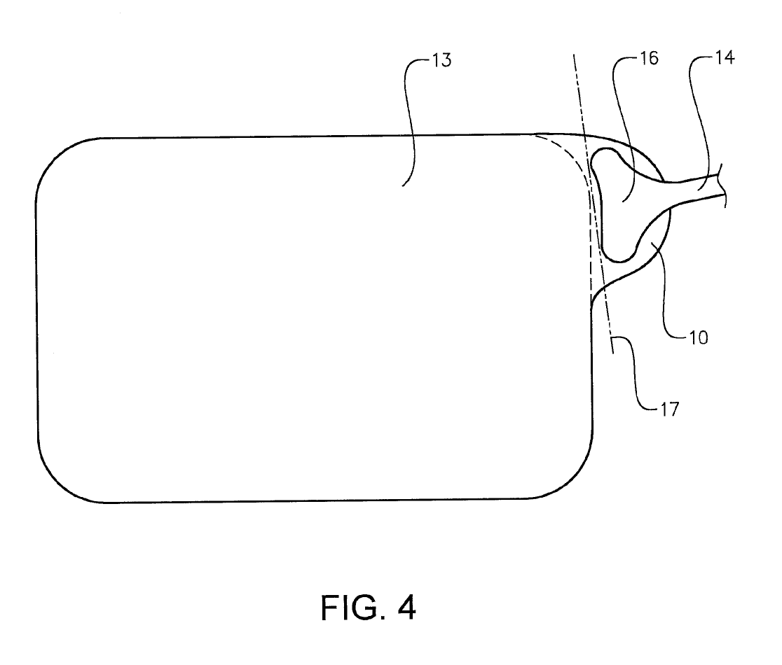

FIG. 4 shows a bottom view of a further example of a food tray according to the invention. In this example, the attachment section 16 of the removal tab is attached to a bottom attachment section 10 of the removable bottom, which extends out from the removable bottom, outside of the seal between the removable bottom and the lower rim. In this example, the bottom attachment section 10 is provided at a corner of the removable bottom. The removal tab will in this way extend diagonally over the removable bottom, such that the removable bottom will start to peel off in one corner. This simplifies the removal of the removable bottom since the pulling forces will act with an angle, starting to remove the removable bottom at a corner. When the removal tab has been attached to the bottom attachment section of the removable bottom, the bottom attachment section together with the removal tab will be folded along folding line 17, such that the removal tab will be double folded. The handle 9 of the removal tab will thereafter be attached to the side wall at the opposite corner in a removable way, such that the handle is held in place before the tab is to be pulled. The bottom attachment section with the removal tab is folded along the folding line after the removable tab is attached to the bottom attachment section of the removable bottom.

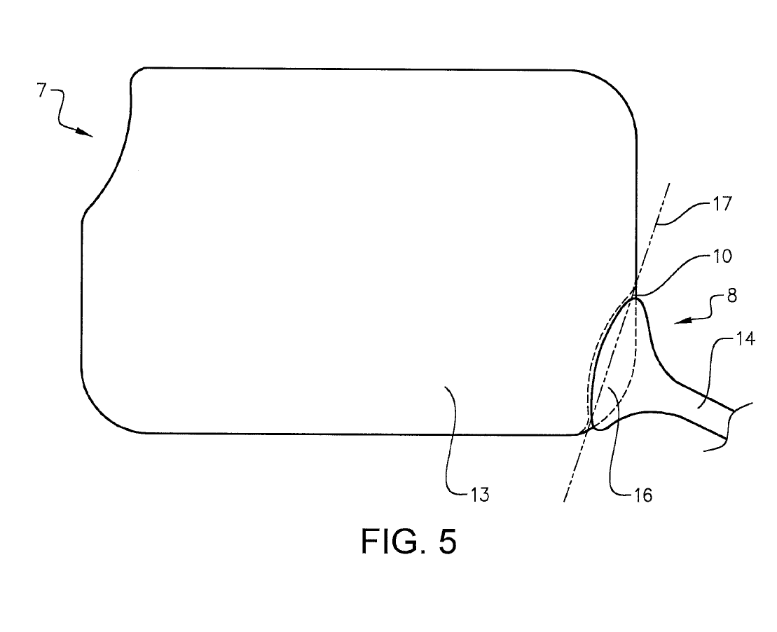

FIG. 5 shows a bottom view of a further example of a food tray according to the invention. In this example, the food tray is provided with concave sections 7, 8, as shown in FIG. 1. The attachment section 16 of the removal tab is attached to a bottom attachment section 10 of the removable bottom, which in this example extends in the concave section 8, outside of the seal between the removable bottom and the lower rim. In this way, further bottom foil material can be saved, since the bottom attachment section does not extend outside the general outer shape of the side wall module. The removal tab will in this way extend diagonally over the removable bottom, such that the removable bottom will start to peel off in one corner. This simplifies the removal of the removable bottom since the pulling forces will act with an angle, starting to remove the removable bottom at a corner. When the removal tab has been attached to the bottom attachment section of the removable bottom, the bottom attachment section together with the removal tab will be folded along folding line 17, such that the removal tab will be double folded. The handle 9 of the removal tab will thereafter be attached to the side wall at the opposite corner in a removable way, such that the handle is held in place before the tab is to be pulled. The bottom attachment section with the removal tab is folded along the folding line after the removable tab is attached to the bottom attachment section of the removable bottom.

When attaching the attachment section of the removal tab to the removable bottom inside the seal between the removable bottom and the lower rim, as shown in FIGS. 2 and 3, a counterdie is held at the other side of the removable bottom when e.g. a heat welding tool is applied the attachment section.

When attaching the attachment section of the removal tab to the bottom attachment section of the removable bottom, outside of the seal between the removable bottom and the lower rim, as shown in FIGS. 4 and 5, a counterdie may also be used at the other side of the bottom attachment section when e.g. a heat welding tool is applied the attachment section. It is also possible to grip the bottom attachment section with a gripping tool and to fold the bottom attachment section along the folding line before the attachment section of the removal tab is fixedly attached to the bottom attachment section. The gripping tool may fold the bottom attachment section by 180 degrees before the removal tab is attached, or may fold the bottom attachment section by e.g. 90 degrees before the removal tab is attached. In this case, the gripping tool will fold the bottom attachment section with the removal tab by an additional 90 degrees after the removal tab is attached, such that the removal tab will be double folded. One advantage of using a gripping tool in this way and to fold the bottom attachment section before the removal tab is attached is that the stress acting on the seal between the removable bottom and the lower rim can be reduced. A further advantage is that the folding of the removal tab and the attachment of the removal tab can be combined in one tool, which saves time and process steps.

The food tray is adapted to be supplied with food in a filling station at a ready meal producer. This may be either a manually operated filling station or an automated filling station. When all food products are inserted into the food tray, a lid is mounted to the upper rim of the food tray. The lid is preferably mounted to the food tray in a heat sealing operation, but it is also possible to use a lid that is not fixedly attached to the upper rim, e.g. when fresh ready meals are prepared for catering. Commonly known heat sealing apparatuses or machines comprising a heated plate may be used, but since the lid should not be removable, other materials, temperatures and processing times may be used.

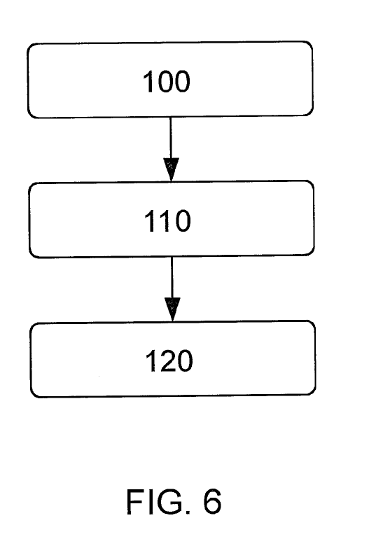

A flow chart of a method for producing a food tray, where the food tray comprises a side wall module and a removable bottom attached to a lower rim of the side wall module in a detachable manner is shown in FIG. 6. The removable bottom can be removed from the side wall module by the use of a removal tab attached to the removable bottom, where the removal tab is a separate removal tab fixedly attached to the removable bottom.

In step 100, a food tray having side walls and a bottom part is produced by either thermoforming or injection moulding. A suitable material is polypropylene (PP) or polyethylene terephthalate (PET). By using PET, a food tray having a removable bottom that withstands temperatures in the range between 150° C. up to 210° C. can be obtained.

In step 110, a bottom foil is attached to a lower rim of the side wall module in a detachable manner. The bottom foil is provided from a roll of foil which is attached to the lower rim, and which is thereafter cut out from the roll of foil.

In step 120, a removal tab is attached to the removable bottom in a fixed manner. The removal tab is attached using an attachment section of the removal tab, where the attachment section is wider than the handle of the removal tab. The removal tab is also made from a foil. The material of the removable bottom is preferably different from the material of the removal tab. The material of the removal tab is further made from a simpler material, since the removal tab must not be attached in a removable manner.

The invention is not to be regarded as being limited to the embodiments described above, a number of additional variants and modifications being possible within the scope of the subsequent patent claims. The food tray may have any size and/or shape.

### REFERENCE SIGNS

1: Food tray
2: Side wall module
3: Longitudinal side wall
4: Longitudinal side wall
5: Transverse side wall
6: Transverse side wall
7: Concave section
8: Concave section
9: Handle
10: Bottom attachment section
11: Upper rim
12: Lower rim
13: Removable bottom
14: Removal tab
15: Lower opening
16: Tab attachment section
17: Folding line

1. Removable bottom (13) adapted to be attached to a lower rim (12) of a food tray (1) in a detachable manner, where the removable bottom (13) comprises a removal tab (14), characterized in that removal tab (14) is a separate removal tab (14) fixedly attached to the removable bottom (13) by an attachment section (16).

2. Removable bottom according to claim 1, characterized in that the removable bottom (13) is a foil and that the removal tab (14) is a foil.

3. Removable bottom according to claim 2, characterized in that the removable bottom (13) foil and the removal tab (14) foil are made from two different materials.

4. Removable bottom according to any of claims 1 to 3, characterized in that the removal tab (14) is attached at a corner of the removable bottom (13).

5. Removable bottom according to any of claims 1 to 3, characterized in that the removal tab (14) is attached along a short side of the removable bottom (13).

6. Removable bottom according to any of claims 1 to 3, characterized in that the removable bottom (13) comprises an additional attachment section (10) extending from the removable bottom (13), where the removal tab (14) is attached to the attachment section (10).

7. A food tray (1) comprising a side wall module (2) and a removable bottom (13) according to any of claims 1 to 6.

8. Method of producing a food tray, where the food tray (1) comprises a side wall module (2) and a removable bottom (13) attached to a lower rim (12) of the side wall module (2) in a detachable manner, and where the removable bottom (13) can be removed from the side wall module (2) by the use of a removal tab (14) attached to the removable bottom (13), characterized in that the method comprises the steps of:
producing a side wall module having side walls and a lower opening,
attaching a bottom foil to a lower rim of the side wall module in a detachable manner, and
attaching the removal tab to the removable bottom.

9. Method according to claim 8, characterized in that the removal tab (14) is attached to the removable bottom (13) after the removable bottom (13) is attached to the lower rim (12) of the side wall module (2).

10. Method according to claim 8 or 9, characterized in that the removal tab (14) is attached to a corner of the removable bottom.

11. Method according to claim 8 or 9, characterized in that the removal tab (14) is attached along a short side of the removable bottom.

12. Method according to any of claims 8 to 11, characterized in that the removable bottom is a foil and the removal tab is a foil, and where the removable bottom foil and the removal tab foil are made from two different materials.

13. Method according to any of claims 8 to 12, characterized in that the removal tab is attached to the removable bottom (13) at a bottom attachment section (10) extending outside of the lower rim of the side wall module.

14. Method according to claim 13, characterized in that the removal tab is attached to the bottom attachment section after the bottom attachment section is folded.

15. Method according to claim 14, characterized in that the bottom attachment section is folded by 180 degrees before the removal means is attached.
